(19) United States
(12) Patent Application Publication
(10) Pub. No.: US 2021/0076474 A1
(43) Pub. Date: Mar. 11, 2021

(54) Wirelessly Activated Light

(71) Applicant: Process4, Inc., Chagrin Falls, OH (US)

(72) Inventor: Matthew Hanson, Chagrin Falls, OH (US)

(21) Appl. No.: 17/009,875

(22) Filed: Sep. 2, 2020

Related U.S. Application Data
(60) Provisional application No. 62/898,645, filed on Sep. 11, 2019.

(51) Int. Cl. H05B 47/19; F21V 21/08; F21V 23/04; B60Q 1/00; B60Q 1/26; B60Q 5/00

(52) U.S. Cl. CPC H05B 47/19; F21V 21/08; F21V 23/0407; H04W 4/80; B60Q 1/2615; B60Q 5/00; B60Q 1/2696; B60Q 1/0088

(57) ABSTRACT

An illumination device which is activated remotely via a wireless communication interface such as Bluetooth. The illumination device includes one or more lights, a housing, and an attachment arrangement for mounting to various surfaces in a temporary or semi-permanent manner.

The present disclosure claims priority on U.S. Provisional Application Ser. No. 62/898,645 filed Sep. 11, 2019, which is incorporated herein by reference.

The present disclosure sets forth an illumination device which is activated remotely via a wireless communication interface such as, but not limited to, Bluetooth. The illumination device is attachable to various mounting surfaces in a temporary or semi-permanent manner. However, it is to be appreciated that the present disclosure is also amenable to other like applications.

### BACKGROUND

Some illumination devices commonly provided as aftermarket products are placed by a user in locations where a light source was not previously available or feasible. In addition, other illumination devices are provided aftermarket so that a different type of illumination can be provided in a specific location (e.g., a strobing light). Often the location where such aftermarket illumination devices can be placed is limited by whether a power source is available or whether a switch or other activation arrangement can be accessed easily by a user. Alternatively, the illumination device can be provided with a bulky or inconvenient extension cord or other physical/mechanical arrangement which permits a user to activate the device even when the device is positioned in a difficult-to-reach location, such as on an automobile.

It would be desirable to provide an improved illumination device which includes one or more wireless communication arrangement for communicating with a remote user device, such as a smartphone, such that the illumination device can be activated remotely.

### SUMMARY OF DESCRIPTION

The present disclosure sets forth an illumination device which is activated and/or controlled remotely via a wireless communication interface such as, but not limited to, Wi-Fi, Bluetooth, Cellular Communication, Radio Frequency Identification, etc. The illumination device is configured to be attachable to various mounting surfaces in a temporary or semi-permanent manner.

In accordance with one non-limiting aspect of the present disclosure, an illumination device is described which is attached to a mounting surface on a desired location, such as on a vehicle, stage, platform, dock, boat, etc., and which illumination device includes one or more lights, an attachment arrangement, and a wireless communication interface. A housing is also included which houses and protects the one or more lights and wireless communication interface.

In accordance with another non-limiting aspect of the present disclosure, the one or more lights of the illumination device include light-emitting diodes (LEDs), incandescent lamps, compact fluorescent lamps, halogen lamps, metal halide lamps, fluorescent tube, neon lamps, high intensity discharge lamps, low pressure sodium lamps, etc.

In accordance with another non-limiting aspect of the present disclosure, the illumination device is configured to display multiple colors. In one non-limiting embodiment, the illumination device includes a light that can display multiple colors. In another non-limiting embodiment, the illumination device includes multiple lights that can be used together to display multiple colors. In one specific arrangement, the illuminating device includes a plurality of LED lights wherein one LED light generates a blue light, one LED light generates a green light and one LED light generates a red light and that these LED lights are used together to create different colored light and white light across the visual light spectrum (e.g., white, red, orange, yellow, green, cyan, blue, indigo, and violet, etc.). In another specific arrangement, the illuminating device includes a plurality of LED lights wherein one LED light generates a blue light, one LED light generates a green light, one LED light generates a yellow light, and one LED light generates a red light and that these LED lights are used together to create different colored light and white light across the visual light spectrum. For instance, the one or more lights of the illumination device can be caused to illuminate a yellow or red color used for indicating caution or a warning. The one or more lights of the illumination device can be caused to illuminate a white, red, and/or blue color used for indicating an emergency (e.g., colors used on emergency vehicles, etc.). As can be appreciated, the one or more lights of the illumination device can be caused to illuminate other or additional colors.

In accordance with another non-limiting aspect of the present disclosure, the one or more lights of the illumination device can have a plurality of illumination display patterns. In one non-limiting embodiment, the plurality of illumination display patterns can include a strobing effect using one or more colors.

In accordance with another non-limiting aspect of the present disclosure, the illumination device includes a wireless communication interface configured to interact with a remote user device, such as a portable smart device (e.g., portable smartphone, portable tablet, etc.), portable computer, portable remote control device, etc. In one non-limiting embodiment, the wireless communication interface includes Bluetooth. In another non-limiting embodiment, the wireless communication interface is configured to control the one or more lights of the illumination device by turning them on/off, changing a color, and/or changing the illumination pattern of the light and/or a plurality of lights.

In accordance with another non-limiting aspect of the present disclosure, the illumination device can be provided in various shapes, including but not limited to, a circular/dot shape, a rectangular shape, and a plug shape.

In accordance with another non-limiting aspect of the present disclosure, the illumination device includes a power arrangement. The power arrangement includes, but is not limited to, a direct plug-in arrangement for connecting to a dedicated power source, wire plugs for connecting to a dedicated power source, loose wires for connecting to a variety of different power sources, and a battery pack included with the light housing.

In accordance with another non-limiting aspect of the present disclosure, the illumination device includes a housing having an attachment arrangement configured to mount the illumination device to a mounting surface. The attachment arrangement includes, but is not limited to, a plug configured to attach directly to a socket (e.g., vehicle socket ([e.g., a headlight socket, vehicle rear light socket, etc.], lamp socket, ceiling light socket, general light socket, etc.), one or more magnets, adhesives, melted connection arrangement, solder or weld connection arrangement, and/or mechanical fastener (e.g., screw, pin, rivet, hook and loop fastener, mushroom head connector, snap, clip, etc.). In one non-limiting embodiment, the attachment arrangement on the illumination device includes a plug that is configured to be plugged or connected to an existing socket without need of an adaptor. In such an embodiment, an OEM light that is connected in a socket (e.g., vehicle light socket, etc.) can be simply removed from the socket. The illumination device in accordance with the present disclosure can be simply plugged into the socket without having to modify the socket or modify the attachment arrangement on the illumination device. In another non-limiting embodiment, the attachment arrangement is connected to the housing to enable the housing to be temporarily connected to a structure on a vehicle (e.g., bumper, hood, vehicle roof, vehicle front grill, trunk door, rear door, etc.) or other structure (e.g., pole, deck, railing, floor, ceiling, roof, door, etc.).

In accordance with another non-limiting aspect of the present disclosure, one or more illumination devices are connected wirelessly or by a wire to a control box that is spaced from the one or more illumination devices, and wherein the control box is in wireless communication with a remote source (e.g., portable smart device, portable smartphone, portable remote computer, etc.). The one or more illumination devices can include a wireless communication interface and a control module when the one or more illumination devices are in wireless communication with the control box. When the one or more illumination devices include a wired connection with the control box, the one or more illumination devices can optionally be absent the wireless communication interface or both the wireless communication interface and the control module. The control box includes a wireless communication interface and a control module to enable the control box to send and/or receive information between the control box and the remote source. A same or different wireless communication interface and/or control module can be used to create wireless communication between the one or more illumination devices and the control box. The control module can include a processor, memory, and/or programming that can be used to a) control the operation of one or more lights on the illumination device, b) process received information from the remote source, c) sent information to the remote source, d) process received information from the one or more illumination devices, and/or e) send information by wire and/or wirelessly to the one or more illumination devices. When the control box is wire connected to the one or more illumination devices, the control box can optionally include one or more switches and circuitry to control the operation of the one or more illumination devices.

In accordance with another non-limiting aspect of the present disclosure, the illumination device includes a wireless communication interface and a control module. The wireless communication interface can include a receiver and/or transmitter that is used to receive from a remote source (e.g., portable smart device, portable smartphone, portable remote computer, etc.) and/or transmit information to a remove source. The control module can include a processor, memory, and/or programming that can be used to a) control the operation of one or more lights on the illumination device, b) process received information from the wireless communication interface, and/or c) cause information to be transmitted from the wireless communication interface. Generally, the control module also includes one or more switches and circuitry to control the operation of the one or more lights.

In accordance with another non-limiting aspect of the present disclosure, the illumination device includes one or more light sources capable of displaying a plurality of colors.

In accordance with another non-limiting aspect of the present disclosure, the illumination device and/or the control box includes a control module configured to cause one or more light sources to produce a plurality of illumination display patterns (e.g., a strobing effect [i.e. 5+ flashes per second, 5-50 flashes per second and all values and ranges therebetween], series of flashes that are slower than a strobing effect [i.e., flash every 0.2-30 seconds and all values and ranges therebetween], strobing effect with changing colors, series of flashes that are slower than a strobing effect with different colors, period color changes during a set period, random color changes, lights constantly on, lights constantly on but change colors during a set period of time or randomly change colors while constantly on, turning lights on and off during a set period of time or randomly turning lights on and off, etc.).

In accordance with another non-limiting aspect of the present disclosure, the illumination device and/or control box can include one or more sound generators (e.g., speaker, sound transducer, piezoelectric device, etc.) to generator one or more types of sound, one or more frequencies of sound, one or more sound patterns, etc., and/or to enable a user to broadcast music and/or speak from an associated remote user device and out through the one or more sound generators. The one or more sound generators can be partially or fully housed in the housing of the illumination device, or be mounted partially or fully on the exterior of the housing and/or one or more of the light sources. The illumination device can include a control module to control the operation of the one or more sound generators. The control module can be the same or a different control module than is used to control the one or more light sources.

In accordance with another non-limiting aspect of the present disclosure, the wireless communication interface of the illumination device and/or control box is configured to receive commands over a wireless network from a corresponding wireless communication interface of an associated remote user device (e.g., portable smartphone, portable smart device, portable remote control, portable tablet, portable computer, etc.). In one non-limiting embodiment, the wireless communication interface can include one or more of a Bluetooth driver, a Wi-Fi driver, and/or a cellular network card. In another non-limiting embodiment, the maximum communication range between the wireless communication interface and the associated remote user device is 1000 m (3281 ft), typically 400 m (1312 ft.), more typically 100 m (328 ft.), and still more typically 50 m (164 ft.).

In accordance with another non-limiting aspect of the present disclosure, the associated remote user device can include an app or software program that is loaded on the associated remote user device to enable the user to control the illumination device and/or communicate with the control box from a remote location (e.g., user located inside vehicle and the illumination device connected to an exterior light socket or a location on the exterior of the vehicle, user located a plurality of feet from the illumination device or control box, etc.). The app or software can be downloadable, loadable or preloaded on to the associated remote user device. The app or software can be used to: 1) turn the illumination device off and on; 2) monitor whether one or more lights on the illumination device are burned out and/or operating properly; 3) monitor whether one or more illumination devices are operating properly; 4) monitor whether the control box is operating properly; 5) monitor power levels of the illumination device and/or control box; 6) monitor signal strength and/or loss of signal between the associated remote user device and one or more illumination devices and/or control box; 7) monitor signal strength and/or loss of signal between the control box and one or more illumination devices; 8) control light illumination pattern of the one or more lights on one or more of the illumination devices; 9) control the color of the one or more lights on one or more of the illumination devices; 10) control intensity, brightness or lumen output of the one or more lights on one or more of the illumination devices; 11) control flashing or strobing frequency of one or more lights on one or more of the illumination devices; 12) control operation of the one or more sound generators; 13) set the one or more sound generators to speaker mode to enable the user to speak into the associated remote user device and broadcast the speech through the one or more sound generators; 14) cause the one or more sound generators to broadcast or generate one or more types of predefined or preprogrammed sounds, notices, warnings or speeches; 15) control sound patterns, volume, and/or type of sound broadcasted or generated by the one or more sound generators; and/or 16) update software and/or other programing on the one or more illumination devices and/or control box.

One non-limiting object of the present disclosure is to provide a light control system for wirelessly controlling illumination on a vehicle, said light control system comprises: a vehicle, said vehicle including a light socket and electrical wiring for providing power to said light socket; an illumination device system, said illumination device system including a) an illumination device, or b) an illumination device and a control box; said illumination device including a housing, an attachment arrangement on said housing, a light, and an illumination device communication arrangement, and; a remote user device located remotely from said illumination device; said remote user device including software and a user device wireless communication interface to control operation of said illumination device.

Another non-limiting object of the present disclosure is to provide an illumination device communication arrangement that includes a control module and a wireless communication interface, said wireless communication interface configured to enable wireless communication between said illumination device communication arrangement and said user device wireless communication interface.

Another non-limiting object of the present disclosure is to provide an attachment arrangement electrically connected to an existing light socket in said vehicle, said illumination device powered via said electrical wiring of said vehicle.

Another non-limiting object of the present disclosure is to provide an illumination device that includes a plurality of said lights located on said housing, said illumination device includes at least one LED light.

Another non-limiting object of the present disclosure is to provide an attachment arrangement configured to be connected to a non-electrical connector on a vehicle, said housing including an internal power supply or electrical wires connected to electrical wiring of said vehicle.

Another non-limiting object of the present disclosure is to provide an attachment arrangement that includes a magnet, hook and loop fastener, releasable adhesive, suction cup attachment, clamp, zip tie, or worm gear clamp.

Another non-limiting object of the present disclosure is to provide a light on said illumination device configured to a) display a plurality of colors, b) rapidly flash to create a strobe effect, and/or b) flash to create a blinking effect.

Another non-limiting object of the present disclosure is to provide a housing that includes a sound generating source controlled by said remote user device.

Another non-limiting object of the present disclosure is to provide a remote user device which is a smartphone that includes a software app loaded on said smartphone to enable said smartphone to wirelessly communicate via Bluetooth to a wireless communication interface located in said illumination device or in control box to control operation of said illumination device.

Another non-limiting object of the present disclosure wherein the software app on said smartphone is configured to enable a user of said smartphone to: 1) turn said illumination device off and on; 2) monitor whether one or more of said lights on said illumination device is burned out and/or operating properly; 3) monitor whether said illumination device is operating properly; 4) monitor whether said control box is operating properly; 5) monitor a power level of said illumination device and/or said control box; 6) monitor signal strength and/or loss of signal between said remote user device and said illumination device and/or said control box; 7) monitor signal strength and/or loss of signal between said control box and said illumination device; 8) control light illumination pattern of the one or more of said lights on said illumination device; 9) control a color of one or more of said lights on said illumination device; 10) control intensity, brightness or lumen output of one or more of said lights on said illumination device; 11) control flashing or strobing frequency of one or more said lights on said illumination device; 12) control operation of a sound generator; 13) set said sound generator to speaker mode to enable said user to speak into said remote user device and broadcast speech through said sound generator; 14) cause said sound generator to broadcast or generate one or more types of predefined or preprogrammed sounds, notices, warnings, or speeches; 15) control sound patterns, volume, and/or type of sound broadcasted or generated by said sound generator; and/or 16) update software and/or other programing on said illumination device and/or said control box.

Another non-limiting object of the present disclosure is to provide a method for controlling an illumination system for use on a vehicle comprising: providing a vehicle; said vehicle including a light socket and electrical wiring for providing power to said light socket; providing an illumination device, said illumination device includes a housing, an attachment arrangement on said housing, a light, and an illumination device communication arrangement; said attachment arrangement of said housing inserted into said light socket; said illumination device powered by said light socket; providing a portable remote user device; said portable remote user device including a user device wireless communication interface that can wirelessly communicate with said illumination device; said user device wireless communication interface including loaded illumination device software; and, controlling operation of said illumination device by said illumination device software on said portable remote user device; said illumination device software on said portable remote user device enabling said portable remote user device to wirelessly communicate via Bluetooth to a said wireless communication interface on said illumination device; said operation including one or more of 1) turning said illumination device off and on, 2) monitoring whether one or more of said lights on said illumination device is burned out and/or operating properly, 3) monitoring whether said illumination device is operating properly, 4) monitoring a power level of said illumination device, 5) monitoring signal strength and/or loss of signal between said portable remote user device and said illumination device, 6) controlling light illumination pattern of the one or more of said lights on said illumination device, 7) controlling a color of one or more of said lights on said illumination device, 8) controlling intensity, brightness or lumen output of one or more of said lights on said illumination device, 9) control flashing or strobing frequency of one or more said lights on said illumination device, and/or 10) update software and/or other programming on said illumination device.

Another non-limiting object of the present disclosure is to provide a method for installing a non-OEM illumination system on a vehicle, said method comprises: providing a vehicle; said vehicle including a light socket and electrical wiring for providing power to said light socket; providing an illumination device, said illumination device including a housing, an attachment arrangement on said housing, a light, and an illumination device communication arrangement; providing a portable remote user device; said portable remote user device including a user device wireless communication interface that can wirelessly communicate with said illumination device; removing an existing light from said light socket; inserting said attachment arrangement of said housing of said illumination device into said light socket; powering said illumination device from power from said light socket; loading illumination device software on said portable remote user device; and, controlling operation of said illumination device by said illumination device software on said portable remote user device; said illumination device software on said portable remote user device enables said portable remote user device to wirelessly communicate via Bluetooth to a said wireless communication interface on said illumination device; said operation including one or more of: 1) turning said illumination device off and on; 2) monitoring whether one or more of said lights on said illumination device is burned out and/or operating properly; 3) monitoring whether said illumination device is operating properly; 4) monitoring a power level of said illumination device; 5) monitoring signal strength and/or loss of signal between said portable remote user device and said illumination device; 6) controlling light illumination pattern of the one or more of said lights on said illumination device; 7) controlling a color of one or more of said lights on said illumination device; 8) controlling intensity, brightness or lumen output of one or more of said lights on said illumination device; 9) control flashing or strobing frequency of one or more said lights on said illumination device; and/or 10) update software and/or other programing on said illumination device.

These and other aspects and advantages will become apparent from the following description taken together with the accompanying drawings.

### BRIEF DESCRIPTION OF THE DRAWINGS

Reference may now be made to the drawings, which illustrate various embodiments that the disclosure may take in physical form and in certain parts and arrangement of parts wherein:

FIG. 1A is an illustration according to one non-limiting embodiment of the present disclosure which shows a first exemplary plug-type illumination device configured to be activated/controlled by a wireless arrangement;

FIG. 1B is an illustration according to one non-limiting embodiment of the present disclosure which shows a second exemplary plug-type illumination device configured to be activated/controlled by a wireless arrangement;

FIG. 2 is an illustration according to one non-limiting embodiment of the present disclosure which shows a circular/dot-shaped illumination device configured to be activated/controlled by a wireless arrangement;

FIG. 3 is an illustration according to one non-limiting embodiment of the present disclosure which shows a rectangular-shaped illumination device configured to be activated/controlled by a wireless arrangement;

FIG. 4 is schematic illustration according to one non-limiting embodiment of the present disclosure which shows an exemplary illumination device being communicatively connected to an associated remote user device;

FIG. 5 is an illustration according to one non-limiting embodiment of the present disclosure which shows an exemplary plug-type illumination device being communicatively connected to an associated remote user device; and,

FIG. 6 is an illustration according to one non-limiting embodiment of the present disclosure which shows a plurality of exemplary plug-type illumination devices being communicatively connected to a remotely located control box, and wherein the control box is communicatively connected to an associated remote user device.

### DETAILED DESCRIPTION OF NON-LIMITING EMBODIMENTS

A more complete understanding of the articles/devices, processes, and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

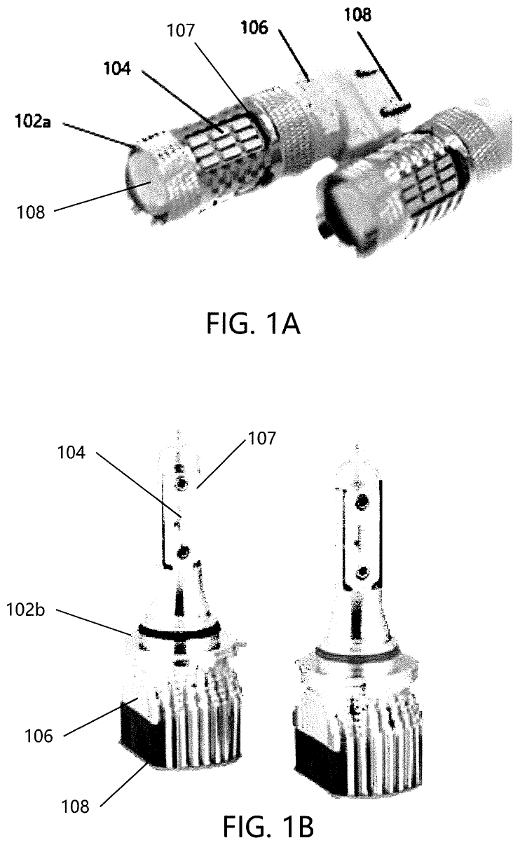

Referring now to the drawings, wherein the showings are for the purpose of illustrating non-limiting embodiments of the disclosure only and not for the purpose of limiting the same, FIGS. 1-4 illustrate various aspects of an illumination device which is activated remotely via one or more wireless communication arrangement, such as Bluetooth. The illumination device is attachable to various mounting surfaces in a temporary or semi-permanent manner.

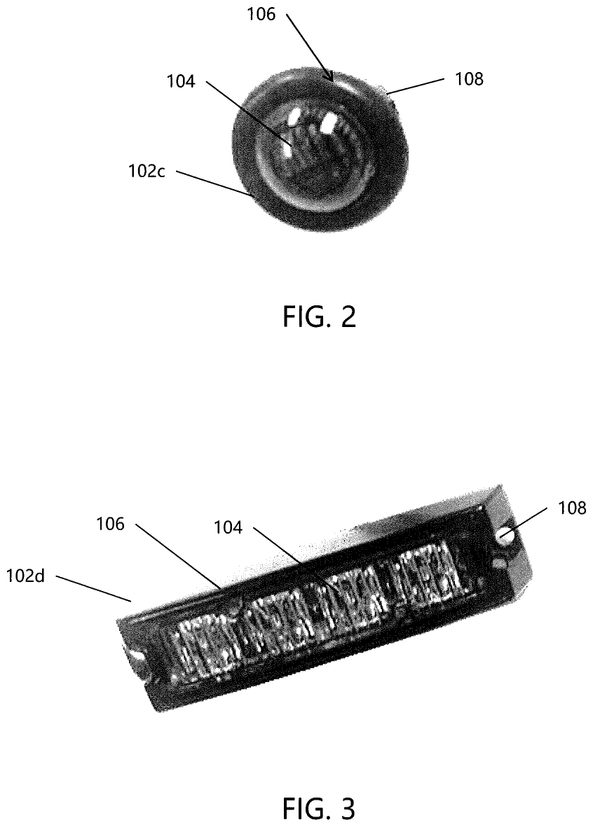

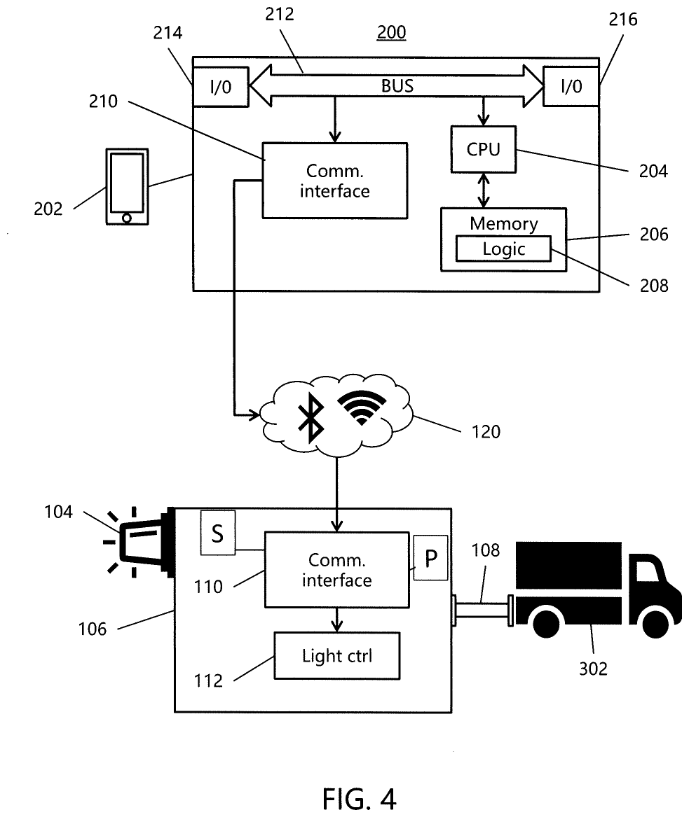

With reference to FIGS. 1-3 and 5-6, various exemplary illumination devices 102a-102e are shown. FIGS. 1A, 1B and 5-6 illustrate three different non-limiting variations of a direct plug-in illumination device 102a, 102b and 102e, respectively; FIG. 2 illustrates a non-limiting circular/dot-shaped illumination device 102c; and FIG. 3 illustrates a non-limiting rectangular-shaped illumination device 102d. FIGS. 4-6 are a schematic illustrations showing non-limiting exemplary illumination devices 102 having circuitry and components for communicatively connecting to an associated remote user device 200 such as a smartphone 202.

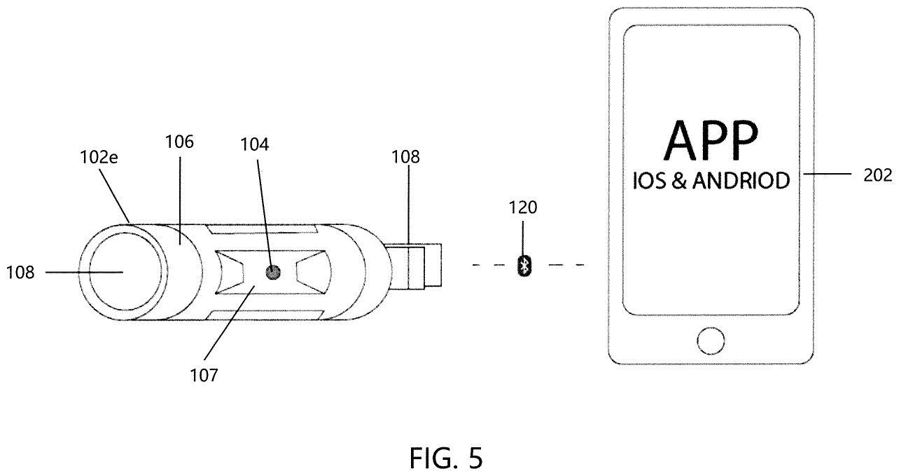

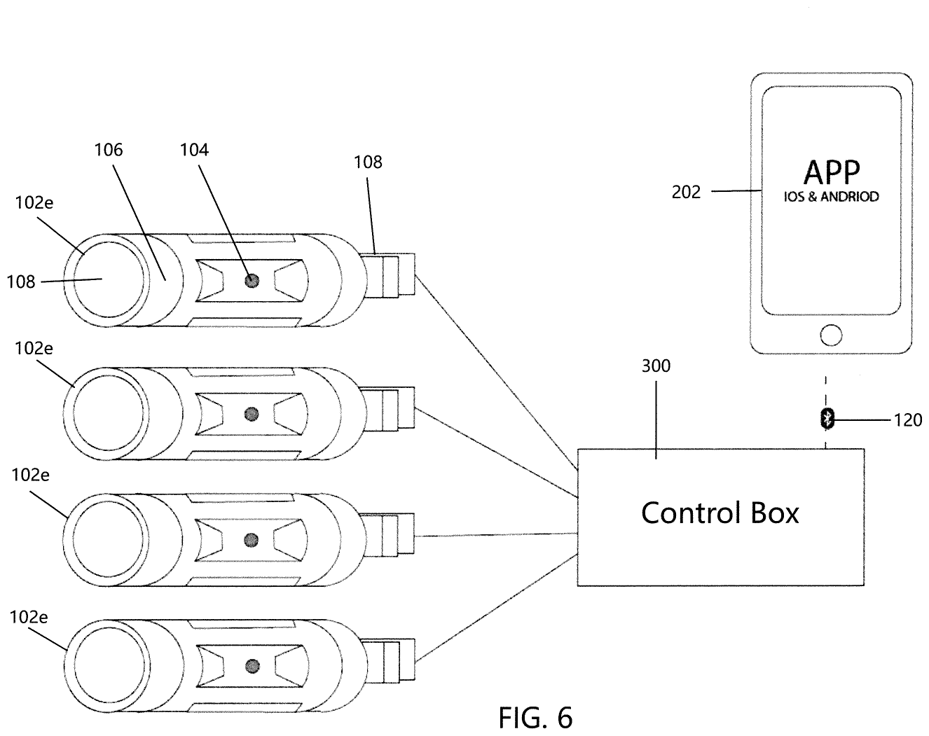

Each of the exemplary illumination devices 102a-102e includes one or more light sources 104, a housing 106, an attachment arrangement 108, a wireless communication interface 110, and a control module 112. As illustrated in FIGS. 1A, 1B, and 5-6, illumination devices 102a, 102b and 102e includes a plurality of light sources 104 connected to the region of the housing located above attachment arrangement 108 of housing 106. As illustrated in FIGS. 1A and 5-6, the upper portion of the housing 106 includes a plurality of recessed regions 107 wherein one or more lights sources are positioned. Generally, housing 106 include two to eight recessed regions 107. As illustrated in FIGS. 1A and 5-6, housing 106 includes four recessed regions 107 wherein adjacent recessed regions 107 are spaced at the same distance from one another. FIG. 1A illustrates that a plurality of light sources 104 are located in each recessed region 107, wherein FIGS. 5-6 illustrate that a single light source is located in each recess region 107. The top end of the housing 106 can optionally include a light lens or light prism 109 that can be used to focus, scatter, filler, etc., the light from the top end of housing 106. The light lens or light prism 109 (when used) is generally formed of a plastic or glass material. FIG. 1B illustrates the housing having two recess regions 107 that each include a plurality of light sources 104. Housing 106 illustrated in FIG. 1B does not include a light lens or light prism on the top of housing 106. The light sources 104 on housing 106 of illumination devices 102a, 102b, and 102e are configured to not be replaceable on the housing; however, this is not required.

Wireless communication interface 110 and control module 112 are schematically illustrated in FIG. 4. Housing 106 is adapted to partially or fully house and protect the one or more light sources 104, wireless communication interface 110, and control module 112. Housing 106 is further configured to provide attachment arrangement 108 for mounting to an associated mounting surface, such as vehicle 302 schematically illustrated in FIG. 4.

According to some non-limiting embodiments, illumination device 102 can be provided in various shapes which are generally defined by the shape of housing 106. In one non-limiting example, housing 106 can define a plug shape as shown by illumination devices 102a, 102b and 102e in FIGS. 1A, 1B, and 5-6, respectively. As another non-limiting example, housing 106 can define a circular/dot shape as shown by illumination device 102c in FIG. 2. As a final non-limiting example, housing 106 can define a rectangular shape as shown by illumination device 102d in FIG. 3.

While the particular shape and size of illumination device 102 are non-limiting, it should be understood that shape and size are generally dictated by the type of location where the illumination device will be mounted. For example, the illumination device have a housing 106 that is plug-shaped at one end (like devices 102a, 102b and 102e) if the illumination device is configured to mount within a designated socket for powering the device (e.g., headlight socket of an associated vehicle, taillight socket of an associated vehicle, lamp socket, etc.). As illustrated in FIGS. 1A, 1B and 5-6, the plug-shaped is configured to be pushed into a socket; however, it can be appreciated that the housing 106 can be configured at one end to enable the illumination device to be screwed or twisted into a socket, etc.

The illumination device may be circular- or dot-shaped (like device 102c) if the device is configured to mount to a surface with limited space (e.g., under the hood of an associated vehicle, on inside surface of a front grill of a vehicle, etc.), or when it is desirable to have a smaller foot-print for the illumination device. The illumination device may be rectangular in shape (like device 102d) if the device is configured to mount to a surface where a large area needs to be illuminated (i.e., front or rear bumper of an associated vehicle, deck, porch, etc.).

As mentioned above, illumination device 102 of the present disclosure includes an attachment arrangement 108 configured to mount illumination device 102 to a mounting surface of various locations. In some non-limiting embodiments, the attachment arrangement 108 is configured to mount illumination device 102 to a mounting surface in a temporary or semi-permanent manner. A semi-permanent mounting arrangement generally refers to an attachment location from which the illumination device is rarely moved, such as during replacement or repair. For example, attachment arrangement 108 for plug-shaped devices 102a and 102b may include one or more clips adapted to semi-permanently mount within an associated socket. Another non-limiting example of a semi-permanent attachment arrangement 108 includes adhesives.

A temporary mounting arrangement is one where the illumination device is placed in a location for a temporary time period or event and thereafter removed (e.g., using illumination device to light a porch or deck for a party, etc.), or where the desired attachment location changes frequently. Non-limiting examples of a temporary mounting arrangement include hook and loop fastener, releasable adhesive, suction cup attachment, magnet, clamp, etc. Generally, the attachment arrangement is located on the bottom or backside of housing 106. For example, attachment arrangement 108 for circular/dot and rectangular-shaped devices 102c, 102d may include a magnetic mounting arrangement located on the backside of housing 106 or the use of other various types of fasteners known in the art.

In some particular non-limiting embodiments, the one or more light sources 104 include LEDs. However, other light sources could also be used without departing from the scope of the present disclosure. Moreover, in other non-limiting embodiments, one or more lights 104 of illumination device 102 can optionally be configured to display a plurality of colors. In addition, or alternatively, one or more lights 104 of illumination device 102 can optionally be configured to display a plurality of illumination display patterns. In one non-limiting example, the plurality of illumination display patterns includes a strobing effect where one or more lights 104 flash rapidly. Other examples of illumination display patterns include, but are not limited to, a) a “constantly on” effect where the one or more lights remain illuminated, b) a blinking effect where the one or more lights blink on and off in a repetitive manner that is generally slower than the rapid flash of the strobing effect, or c) a changing color effect wherein one or more of the lights change color during a certain time period or randomly, and while the lights remain constantly on or blink or strobe.

Other non-limiting embodiments of the illumination device of the present disclosure can optionally include a power arrangement P. The power arrangement can include a direct plug-in arrangement for connecting to a dedicated power source, such as plug-shaped illumination devices 102a and 102b illustrated in FIGS. 1A and 1B, respectively. Alternative or additional examples of a power arrangement include, but are not limited to, a) the use of loose wires for connecting to a variety of different power sources, such as a vehicle's battery, b) a battery pack within the housing of the illumination device, or c) a control box that is hardwire connected to the illumination device, wherein the control box includes an internal power source or is connectable to a variety of different power sources.

Other non-limiting embodiments of the illumination device of the present disclosure can optionally include a sound generating source S that is partially or fully housed in the housing 106 of the illumination device, or mounted partially or fully on exterior of housing 106 and/or one or more of the light sources.

With specific reference to FIGS. 4-5, a schematic block diagram of illumination device 102 and a schematic block diagram of an associated remote user device 200 are illustrated as being communicatively connected to one another. In addition, housing 106 of illumination device 102 is shown as being physically connected to a mounting surface of an associated vehicle 302 by attachment arrangement 108. Each function of the exemplary illumination device 102 discussed above is activated via a wireless communication interface 110 and light control module 112, both of which are generally included within housing 106.

Wireless communication interface 110 is configured to receive commands over a wireless network 120 from a corresponding wireless communication interface 210 of an associated remote user device 200, such as smartphone 202. In some non-limiting embodiments, wireless communication interfaces 110, 210 of illumination device 102 and smartphone 202, respectively, include at least one of a Bluetooth driver, Wi-Fi driver, or cellular network card. In some particular non-limiting embodiments, wireless network 120 includes at least one of a Bluetooth, Wi-Fi, or cellular network. In other particular non-limiting embodiments, light-control module 112 includes at least one of a circuitry or switch which activates one or more lights 104.

Associated remote user device 200, such as smartphone 202, generally includes a central processing unit (CPU) 204 configured to execute logic 208 stored in memory 206. Logic 208 is also referred to as program instructions for controlling the one or more lights 102. In some non-limiting embodiments, logic 208 is embodied in an application configured to run on the smartphone 202. CPU 204, memory 206, logic 208, and wireless communication interface 210 are coupled via a conventional address/data or control bus 212. CPU 204 thus effectuates control over the user device components via bus 212. One or more input-output (“I/O”) devices 214, 216 allow the user device 200 to communicate with the illumination device 102.

Once a command is received from wireless communication interface 210 over wireless network 120, wireless communication interface 110 of illumination device 102 relays the command to light control module 112. Light control module 112 is configured to activate one or more lights 104 in accordance with the command received by wireless communication interface 110. That is, light control module 112 is adapted to activate the different functions of the illumination device, such as displaying one or more of the plurality of colors and displaying the plurality of illumination patterns described above.

Referring now to FIG. 5, an alternative embodiment is illustrated wherein the one or more illumination devices 102 are connected to a control box 300. Control box 300 can include the same components described above with respect to FIG. 4 that are included in housing 106 of illumination device 102. As such, control box 300 can include a wireless communication interface, one or more light control modules, memory, CPU, sound generator, power supply, switches, and/or circuitry (not shown). Control box 300 can be configured to provide power to one or more illumination devices 102; however, this is not required. Control box 300 can communicate with one or more illumination devices 102 by a hardwire connection and/or wirelessly. As illustrated in FIG. 6, control box 300 has a hardwire connection with a plurality of the illumination devices 102. In one non-limiting arrangement, one or more illumination devices 102 are mounted at some location on a vehicle (e.g., front light of a vehicle, taillight of a vehicle, bumper of a vehicle, front grill of a vehicle, hood of a vehicle, roof of a vehicle, fog light of a vehicle, side light of a vehicle, parking light of a vehicle, warning light on a vehicle, spot light on a vehicle, emergency light on a vehicle, etc.), and control box 300 is positioned at a remote location in the vehicle (e.g., trunk, engine compartment, interior of vehicle, dashboard of vehicle, floor of vehicle, door of vehicle, glove compartment, or other storage compartment of vehicle, etc.) from the one or more illumination devices 102. Control box 300 can be hardwired to one or more illumination devices 102 and/or be configured to be in wireless communication with one or more illumination devices 102. The hardwired connection can be created by connecting control box 300 to the existing light circuitry of the vehicle that is used to power a light that was replaced by an illumination device 102. For example, when the illumination device 102 is inserted into the taillight socket of a vehicle, control box 300 can be connected to the existing wiring and/or circuitry of a vehicle used to power and/or control the tailgate lights.

Control box 300 can include a power source (e.g., battery, solar panel, etc.) and/or can be connected to the vehicle power source and/or vehicle electrical circuitry.

As illustrated in FIG. 6, a smart device 202 communicates with control box 300 to send instructions to and/or receive information from control box 300; control box 300 then communicates with one or more illumination devices 102 to control the operation of one or more illumination devices 102.

Wireless communication interface 110 of illumination device 102 and/or control box 300 is configured to receive commands over a wireless network from a corresponding wireless communication interface of associated remote user device 202 (e.g., portable smartphone, portable smart device, portable remote control, portable tablet, portable computer, etc.). The maximum communication range between wireless communication interface 110 and associated remote user device 202 is generally no more than 1000 m, and typically 5-50 m.

The associated remote user device 202 typically includes an app or software program loaded on associated remote user device 202 to enable the user to communicate with/control one or more illumination devices 102 and/or communicate with/control box 300 from a remote location. The app or software can be used to: 1) turn the illumination device off and on; 2) monitor whether one or more lights on the illumination device are burned out and/or operating properly; 3) monitor whether one or more illumination devices are operating properly; 4) monitor whether the control box is operating properly; 5) monitor power levels of the illumination device and/or control box; 6) monitor signal strength and/or loss of signal between the associated remote user device and one or more illumination devices and/or control box; 7) monitor signal strength and/or loss of signal between the control box and one or more illumination devices; 8) control light illumination pattern of the one or more lights on one or more of the illumination devices; 9) control the color of the one or more lights on one or more of the illumination devices; 10) control intensity, brightness or lumen output of the one or more lights on one or more of the illumination devices; 11) control flashing or strobing frequency of one or more lights on one or more of the illumination devices; 12) control operation of the one or more sound generators; 13) set the one or more sound generators to speaker mode to enable user to speak into the associated remote user device and broadcast the speech through the one or more sound generators; 14) cause the one or more sound generators to broadcast or generate one or more types of predefined or preprogrammed sounds, notices, warnings or speeches; 15) control sound patterns, volume, and/or type of sound broadcasted or generated by the one or more sound generators; and/or 16) update software and/or other programming on the one or more illumination devices and/or control box.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the preferred embodiments. These and other modifications of the preferred embodiments as well as other embodiments of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

What is claimed:

1. A light control system for wirelessly controlling illumination on a vehicle, said system comprises:
a vehicle, said vehicle including a light socket and electrical wiring for providing power to said light socket;
an illumination device system, said illumination device system including a) an illumination device, or b) an illumination device and a control box; said illumination device including a housing, an attachment arrangement on said housing, a light, and an illumination device communication arrangement; and,
a remote user device located remotely from said illumination device; said remote user device including software and a user device wireless communication interface to control operation of said illumination device.

2. The light control system as defined in claim 1, wherein said illumination device communication arrangement includes a control module and a wireless communication interface, said wireless communication interface configured to enable wireless communication between said illumination device communication arrangement and said user device wireless communication interface.

3. The light control system as defined in claim 1, wherein said attachment arrangement is electrically connected to an existing light socket in said vehicle, said illumination device powered via said electrical wiring of said vehicle.

4. The light control system as defined in claim 1, wherein said illumination device includes a plurality of said lights located on said housing, said illumination device including at least one LED light.

5. The light control system as defined in claim 1, wherein said attachment arrangement is configured to be connected to a non-electrical connector on a vehicle, said housing including an internal power supply or electrical wires that are connected to electrical wiring of said vehicle.

6. The light control system as defined in claim 1, wherein said attachment arrangement includes a magnet, hook and loop fastener, releasable adhesive, suction cup attachment, clamp, zip tie, or worm gear clamp.

7. The light control system as defined in claim 1, wherein said light on said illumination device is configured to a) display a plurality of colors, b) rapidly flash to create a strobe effect, and/or c) flash to create a blinking effect.

8. The light control system as defined in claim 1, wherein said housing includes a sound generating source controlled by said remote user device.

9. The light control system as defined in claim 1, wherein said remote user device is a smartphone that includes a software app loaded on said smartphone to enable said smartphone to wirelessly communicate via Bluetooth to a wireless communication interface that is located in said illumination device or in control box to control operation of said illumination device.

10. The light control system as defined in claim 1, wherein said software app on said smartphone is configured to enable a user of said smartphone to 1) turn said illumination device off and on, 2) monitor whether one or more of said lights on said illumination device is burned out and/or operating properly, 3) monitor whether said illumination device is operating properly, 4) monitor whether said control box is operating properly, 5) monitor a power level of said illumination device and/or said control box, 6) monitor signal strength and/or loss of signal between said remote user device and said illumination device and/or said control box, 7) monitor signal strength and/or loss of signal between said control box and said illumination device, 8) control light illumination pattern of the one or more of said lights on said illumination device, 9) control a color of one or more of said lights on said illumination device, 10) control intensity, brightness, or lumen output of one or more of said lights on said illumination device, 11) control flashing or strobing frequency of one or more said lights on said illumination device, 12) control operation of a sound generator, 13) set said sound generator to speaker mode to enable said user to speak into said remote user device and broadcast speech through said sound generator, 14) cause said sound generator to broadcast or generate one or more types of predefined or preprogrammed sounds, notices, warnings, or speeches, 15) control sound patterns, volume, and/or type of sound broadcasted or generated by said sound generator, and/or 16) update software and/or other programing on said illumination device and/or said control box.

11. A method for controlling an illumination system for use on a vehicle, said method comprises:
providing a vehicle, said vehicle including a light socket and electrical wiring for providing power to said light socket;
providing an illumination device, said illumination device including a housing, an attachment arrangement on said housing, a light, and an illumination device communication arrangement; said attachment arrangement of said housing inserted into said light socket; said illumination device powered by said light socket;
providing a portable remote user device, said portable remote user device including a user device wireless communication interface that can wirelessly communicate with said illumination device; said user device wireless communication interface including loaded illumination device software; and,
controlling operation of said illumination device by said illumination device software on said portable remote user device, said illumination device software on said portable remote user device enabling said portable remote user device to wirelessly communicate via Bluetooth to a said wireless communication interface on said illumination device; said operation including one or more of 1) turning said illumination device off and on, 2) monitoring whether one or more of said lights on said illumination device is burned out and/or operating properly, 3) monitoring whether said illumination device is operating properly, 4) monitoring a power level of said illumination device, 5) monitoring signal strength and/or loss of signal between said portable remote user device and said illumination device, 6) controlling light illumination pattern of the one or more of said lights on said illumination device, 7) controlling a color of one or more of said lights on said illumination device, 8) controlling intensity, brightness or lumen output of one or more of said lights on said illumination device, 9) control flashing or strobing frequency of one or more said lights on said illumination device, and/or 10) update software and/or other programing on said illumination device.

12. The method as defined in claim 11, wherein said illumination device communication arrangement includes a control module and a wireless communication interface, said wireless communication interface configured to enable wireless communication between said illumination device communication arrangement and said user device wireless communication interface.

13. The method as defined in claim 11, wherein said light on said illumination device is configured to a) display a plurality of colors, b) rapidly flash to create a strobe effect, and/or c) flash to create a blinking effect.

14. A method for installing a non-OEM illumination system on a vehicle, said method comprises:
providing a vehicle, said vehicle including a light socket and electrical wiring for providing power to said light socket;
providing an illumination device, said illumination device including a housing, an attachment arrangement on said housing, a light, and an illumination device communication arrangement;
providing a portable remote user device, said portable remote user device including a user device wireless communication interface that can wirelessly communicate with said illumination device;
removing an existing light from said light socket;
inserting said attachment arrangement of said housing of said illumination device into said light socket;
powering said illumination device from power from said light socket;
loading illumination device software on said portable remote user device; and,
controlling operation of said illumination device by said illumination device software on said portable remote user device, said illumination device software on said portable remote user device enabling said portable remote user device to wirelessly communicate via Bluetooth to a said wireless communication interface on said illumination device; said operation including one or more of 1) turning said illumination device off and on, 2) monitoring whether one or more of said lights on said illumination device is burned out and/or operating properly, 3) monitoring whether said illumination device is operating properly, 4) monitoring a power level of said illumination device, 5) monitoring signal strength and/or loss of signal between said portable remote user device and said illumination device, 6) controlling light illumination pattern of the one or more of said lights on said illumination device, 7) controlling a color of one or more of said lights on said illumination device, 8) controlling intensity, brightness, or lumen output of one or more of said lights on said illumination device, 9) control flashing or strobing frequency of one or more said lights on said illumination device, and/or 10) update software and/or other programing on said illumination device.
